(19) United States
(12) Patent Application Publication
(10) Pub. No.: US 2006/0257107 A1
(43) Pub. Date: Nov. 16, 2006

(54) Recording medium and audiovisual data reproduction method

(75) Inventor: Tatsuya Inokuchi, Tokyo (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(73) Assignee: SONY CORPORATION

(21) Appl. No.: 11/406,915

(22) Filed: Apr. 19, 2006

(30) Foreign Application Priority Data
May 10, 2005 (JP) P2005-137668

(51) Int. Cl. H04N 7/00

(52) U.S. Cl. 386/95

(57) ABSTRACT

The present invention provides driver software for controlling external devices. There is provided a recording medium to be removably loaded in and used by a reproduction apparatus for reproducing audiovisual data including those of sounds and/or images, which stores audiovisual data to be reproduced by the reproduction apparatus, an application program to be executed by a control section of the reproduction apparatus to control reproduction of the audiovisual data and also a predetermined external device connected to the reproduction apparatus by way of a predetermined interface, and a driver program to be executed by the control section of the reproduction apparatus to communicate with the external device by way of the predetermined interface or a downloading program for downloading the driver program from a network, the application program describing an instruction for causing the control section to read out the driver program or download it from the network and execute it before operating the external device.

### CROSS REFERENCES TO RELATED APPLICATIONS

The present invention contains subject matter related to Japanese Patent Application JP 2005-137668 filed in the Japanese Patent Office on May 10, 2005, the entire contents of which being incorporated herein by reference.

### BACKGROUND OF THE INVENTION

1. Field of the Invention

This invention relates to a recording medium where audiovisual data are recorded along with program data and a reproduction method of reproducing audiovisual data from such a recording medium.

2. Description of the Related Art

Reproduction apparatus for reproducing data from optical discs are being more and more equipped with sophisticated functional features. It is believed that a single DVD of the next generation will store one or more than one application programs for controlling external devices along with audiovisual data (AV data) so that a reproduction apparatus will be able to reproduce moving images and, at the same time, control external devices.

When optical discs are made to store application programs along with AV data, it will be possible to control not only closed operations of reproducing games and interactive movies in reproduction apparatus but also various operations based on a combination of a reproduction apparatus and one or more than one external devices. For example, it will be possible to operate a camera in synchronism with the image being reproduced from an optical disc so as to reflect the image picked up by the camera to the image being output to a monitor on a real time basis.

[Patent Document 1] Japanese Patent Application Laid-Open Publication No. Hei 10-143416

### SUMMARY OF THE INVENTION

Meanwhile, it is desirable to use a general purpose local interface such as USB (universal serial bus) for the connection between a reproduction apparatus and an external device. When a general purpose local interface such as USB is utilized, driver software for protocol conversions between the local interface and an application program has to be incorporated in the reproduction apparatus.

However, what external device will be connected to the reproduction apparatus is not predictable and it is not possible to incorporate driver software for each and every type of external device in the reproduction apparatus. While it is possible to incorporate general purpose driver software that is applicable to any external devices, such driver software cannot finely control external devices. For example, storage class devices of USB are compatible only with an asynchronous type command system and hence can neither acquire nor cancel the ongoing status (progress).

Therefore, there is a problem of how to provide a reproduction apparatus adapted to control not only reproduction of moving images but also external devices with driver software for an external device.

Additionally, it is imaginable that there will be scenes where data have to be exchanged not only between a reproduction apparatus and a network (which may be Internet or an in-house network) but also between a reproduction apparatus and an external device when optical discs storing AV data and application programs become available. For example, there will be scenes where contents are copied to a portable player, where contents data and control are exchanged between reproduction apparatus and where data are exchanged between a reproduction apparatus and a card reader for reading prepaid cards or credit cards.

When data are exchanged in this way, such data may more often than not include security-sensitive data. Therefore, it will be necessary to incorporate driver software for a local interface for the purpose of secure communications and protection of data against illegal copying.

However, the data to be protected are various and may be extending from audiovisual data to billing information and any of various different external devices may be used to exchange data. Then, a wide variety of driver software may be needed for secure communications accordingly.

In view of the above identified circumstances, it is desirable to provide a recording medium storing one or more than one application programs for controlling external devices along with audiovisual data and adapted to control various external devices by a reproduction apparatus and also a reproduction method of reproducing audiovisual data by using such a recording medium.

According to the present invention, there is provided a recording medium to be removably loaded in and used by a reproduction apparatus for reproducing audiovisual data including those of sounds and/or images, the recording medium storing: audiovisual data to be reproduced by the reproduction apparatus; an application program to be executed by a control section of the reproduction apparatus to control reproduction of the audiovisual data and also a predetermined external device connected to the reproduction apparatus by way of a predetermined interface; and a driver program to be executed by the control section of the reproduction apparatus to communicate with the external device by way of the predetermined interface or a downloading program for downloading the driver program from a network; the application program describing an instruction for causing the control section to read out the driver program or download it from the network and execute it before operating the external device.

Thus, a recording medium according to the present invention causes a reproduction apparatus to read out the driver program it stores that matches an external device to be used by the application program it stores.

According to the present invention, there is also provided an audiovisual data reproduction method of reproducing audiovisual data including those of sounds and/or images stored in a recording medium by means of a reproduction apparatus, the method including the steps of: storing audiovisual data to be reproduced by a reproduction apparatus, an application program to be executed by the control section of the reproduction apparatus to control reproduction of the audiovisual data and also a predetermined external device connected to the reproduction apparatus by way of a predetermined interface and a driver program to be executed by the control section of the reproduction apparatus to communicate with the external device by way of the predetermined interface or a downloading program for downloading the driver program from a network; causing the control section to read out audiovisual data and the application program from the recording medium and reproduce and execute the application program; and causing the control section to read out the driver program or download it from the network and execute it before operating the external device according to a corresponding instruction of the application program.

Thus, an audiovisual data reproduction method according to the present invention causes the control section of a reproduction apparatus to read out the driver program that is stored in a recording medium and matches an external device to be used by the application program also stored in the recording medium.

A recording medium according to the present invention as defined above causes a reproduction apparatus to read out the driver program it stores that matches an external device to be used by the application program it stores, and execute the driver program.

With this arrangement, a reproduction apparatus adapted to use a recording medium according to the invention can be connected to any of a variety of external devices and finely control the external device.

An audiovisual data reproduction method according to the present invention as defined above causes the control section of a reproduction apparatus to read out the driver program that is stored in a recording medium and matches an external device to be used by the application program also stored in the recording medium.

With this arrangement, an audiovisual data reproduction method according to the invention can reproduce audiovisual data and also finely control any of a variety of external devices.

### BRIEF DESCRIPTION OF THE DRAWINGS

FIG. 1 is a schematic illustration of an AV system for outputting video and audio data stored in a recording medium according to the present invention;

FIG. 2 is a schematic block diagram of a reproduction apparatus for reproducing data from an optical disc realized by applying the present invention, illustrating the internal configuration thereof;

FIG. 3 is a schematic illustration of the structure of a plurality of data stored in an optical disc realized by applying the present invention;

FIG. 4 is a schematic block diagram of a hierarchized USB driver;

FIG. 5 is a schematic illustration of the structure of a plurality of data stored in an optical disc realized by applying the present invention;

FIG. 6 is a flowchart of the operation of a system controller that can be used for the purpose of the present invention;

FIG. 7 is a schematic illustration of the structure of a program incorporated in advance in the ROM of a reproduction apparatus for reproduction data from an optical disc realized by applying the present invention;

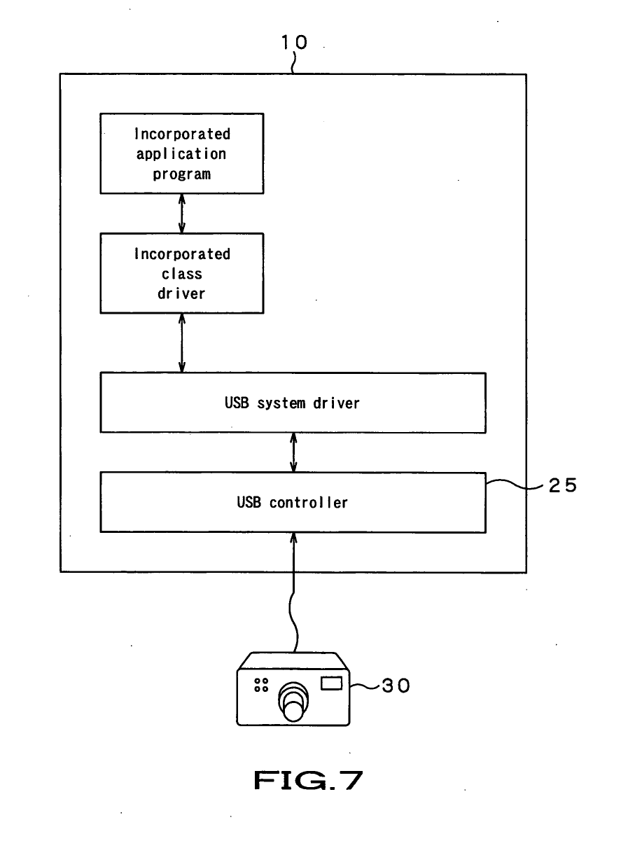

FIG. 8 is a schematic block diagram illustrating the interference of an USB system driver that is produced by a class driver program stored in an optical disc realized by applying the present invention and a class driver stored in a reproduction apparatus for reproducing data from the optical disc;

FIG. 9 is a schematic block diagram illustrating a mediation driver that operates to prevent interference of class drivers;

FIG. 10 is a flowchart of a process to be executed at the time of pseudo-unplugging; and

FIG. 11 is a flowchart of a process to be executed at the time of pseudo-plugging-in.

### DETAILED DESCRIPTION OF THE PREFERRED EMBODIMENTS

Now, an optical disc realized by applying the present invention and an optical disc reproduction apparatus for reproducing data from such an optical disc will be described below by referring to the accompanying drawings.

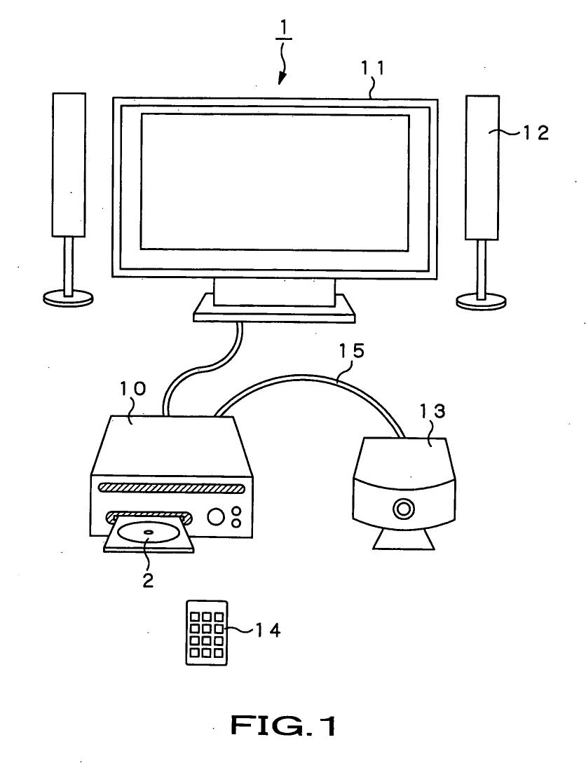

FIG. 1 is a schematic illustration of an AV system 1 for outputting video and audio data stored in a recording medium according to the present invention.

Referring to FIG. 1, the AV system 1 includes an optical disc replaying reproduction apparatus 10 for replaying an optical disc 2 realized by applying the present invention, a monitor 11, a speaker 12, the monitor 11 and the speaker 12 being adapted to output AV data, which are video data and audio data reproduced from the optical disc replaying reproduction apparatus 10, an externally connected device (to be also referred to as USB device hereinafter) 13 connected to the optical disc replaying reproduction apparatus 10 by way of a USB (universal serial bus) interface and a remote controller 14 for transmitting a control signal to the optical disc replaying reproduction apparatus 10 in response to an operation input from the user.

The optical disc 2 is a disc-shaped recording medium that can be removably loaded in an optical disc replaying reproduction apparatus and from which signals are optically reproduced. Note, however, for the purpose of the present invention, a recording medium according to the present invention is by no means limited to an optical disc and may alternatively be a magnetic recording medium or a semiconductor memory so long as it is not incorporated into a reproduction apparatus and removably loaded in the latter.

The externally connected device 13 may be any device so long as it is provided with a USB interface. For example, the externally connected device 13 may be a still camera, a movie camera, a card reader/writer for reading data from and writing data to an IC card or a portable audio player.

The externally connected device 13 operates as slave device for the optical disc replaying reproduction apparatus 10 when it is connected to the optical disc replaying reproduction apparatus 10 by way of the USB cable 15. In other words, the externally connected device 13 operates under the control of the optical disc replaying reproduction apparatus 10 that operates as host device.

While the optical disc replaying reproduction apparatus 10 and the externally connected device 13 are connected by means of a USB interface in the AV system 1, the present invention is by no means limited to the use of a USB interface and any other interface may alternatively be used so long as the externally connected device 13 operates according to an instruction from the optical disc replaying reproduction apparatus 10 by way of it.

While the AV data reproduced from the optical disc replaying reproduction apparatus 10 are data including those of images and music in the instance of this AV system 1, the present invention is by no means limited thereto and the AV data may include only data of images or data of music.

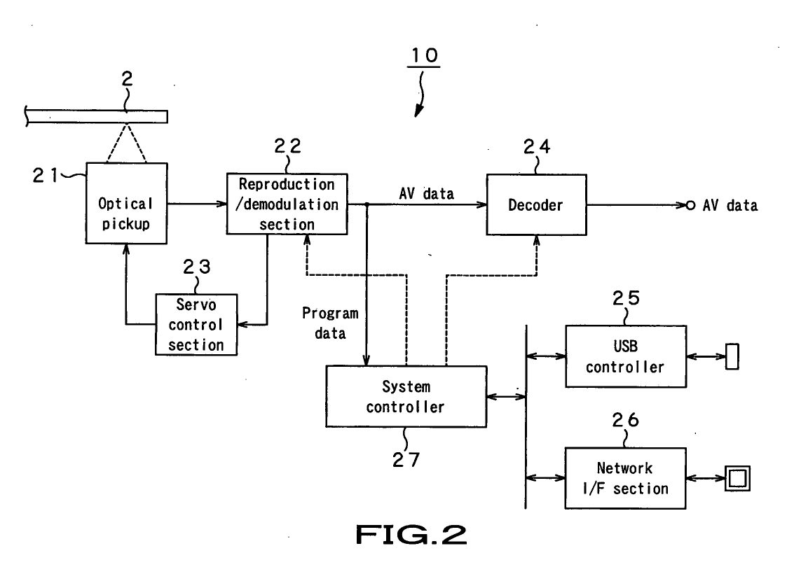

FIG. 2 is a schematic block diagram of the optical disc replaying reproduction apparatus 10, showing the internal configuration thereof.

The optical disc replaying reproduction apparatus 10 includes an optical pickup 21 for optically reading signals recorded on the optical disc 2 and converting them into electric signals, a reproduction/demodulation section 22 for receiving the electric signals output from the optical pickup 21, demodulating the input electric signals and outputting them while also generating various error signals for the purpose of servo control and a servo control section 23 for servo controlling the operation of replaying and driving the optical disc 2 according to the error signals or the like generated by the reproduction/demodulation section 22.

The optical disc replaying reproduction apparatus 10 also includes a decoder 24 for receiving the AV data that are included in the reproduced data output from the reproduction/demodulation section 22, decoding them and outputting them to the monitor 11 and the speaker 12.

The optical disc replaying reproduction apparatus 10 additionally includes a USB controller 25, which is hardware for exchanging data with the externally connected device 13 by way of the USB interface, and a network I/F section 26, which is hardware for external communications by way of a network such as the Internet.

The optical disc replaying reproduction apparatus 10 still additionally includes a system controller 27 for doing various control operations according to an operation program.

The system controller 27 controls the reproduction/demodulation section 22, the servo control section 23 and the decoder 24. It also controls the externally connected device 13 by way of the USB controller 25 and data communications with a network such as the Internet by way of the network I/F section 26. The system controller 27 also receives data from the remote controller 14 and performs related control operations.

The operation program to be executed by the system controller 27 is stored in a nonvolatile memory (not shown). The program to be executed when reproducing AV data is supplied from the optical disc 2 and stored in the memory.

Now, the data stored in the optical disc 2 realized by applying the present invention will be described below.

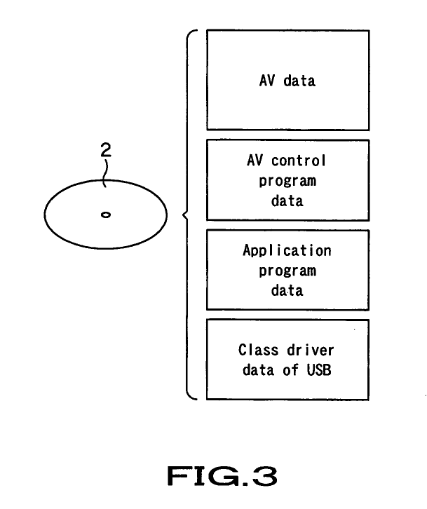

The data generated by a contents producer are recorded on the optical disc 2. More specifically, AV data, AV control program data, application program data and class driver data of USB are stored on the optical disc 2 as shown in FIG. 3.

AV data are contents data such as data of a moving picture. AV data are supplied from the reproduction/demodulation section 22 of the optical disc replaying reproduction apparatus 10 to the decoder 24 and decoded by the decoder 24. The AV data decoded by the decoder 24 are output to the monitor 11 and the speaker 12.

AV control program data are data of the AV control program for controlling the operation of reproducing and outputting the AV data. AV control program data are supplied from the reproduction/demodulation section 22 of the optical disc replaying reproduction apparatus 10 to the system controller 27. The system controller 27 loads the supplied AV control program in the internal memory thereof. The system controller 27 then sequentially executes the instructions described in the AV control program that is loaded in the memory and controls the operation of reproducing and outputting the AV data. When an instruction for interactively outputting images according to a user operation is described in the AV control program, the system controller 27 also controls the timing of outputting an image and the operation of switching images and so forth.

Application program data are data that include an application program for controlling the operation of the externally connected device 13 connected to the apparatus 10 by way of a USB interface. Application program data are supplied from the reproduction/demodulation section 22 of the optical disc replaying reproduction apparatus 10 to the system controller 27. The system controller 27 loads the supplied application program in the internal memory thereof. The system controller 27 then sequentially executes the instructions described in the AV control program that is loaded in the memory and controls the operation of the externally connected device 13.

Note that the application program is executed synchronously with the AV control program. In other words, the system controller 27 controls the operation of the externally connected device 13 in synchronism with the images and the sounds output respectively from the monitor 11 and the speaker 12.

The class driver data of USB are data that include the program of the class driver of USB for driving the USB device (externally connected device) 13 to operate, which USB device is controlled by the application program. For the sake of convenience, beside the class defined by a USB, the program data to be used for special device control that is not defined by the USB are also referred to as class driver herein.

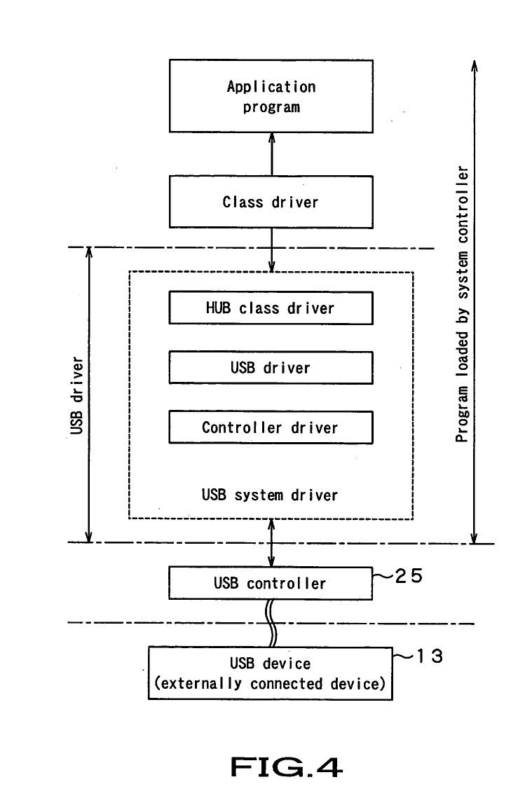

As shown in FIG. 4, a USB driver is hierarchized in terms of its overall configuration and, roughly speaking, has two layers including a layer of a USB system driver and that of a class driver.

The USB system driver is the driver of the lower layer. More specifically, it is the driver of the layer close to the USB controller 25 that is hardware and includes a HUB class driver having a functional feature of controlling the USB controller 25, the USB driver and a controller driver.

The class driver is the driver of the upper layer. More specifically, it is the driver of the layer close to the application program and adapted to convert data between the application program and the USB system driver.

The USB system driver can be commonly used for the optical disc replaying reproduction apparatus 10 and hence is not required to be replaced if a different USB device 13 is connected to the apparatus. Therefore, the USB system driver is stored in the nonvolatile memory or the like of the system controller 27 and loaded in a memory from there when necessary.

To the contrary, the class driver is specific to the USB device 13 connected to the apparatus 10. In other words, the class driver contains control specifications that are specific to the USB device 13.

As described above, the class driver is stored in the optical disc 2. It is read out by the reproduction/demodulation section 22 and loaded on the memory of the system controller 27 from the reproduction/demodulation section 22 when necessary.

The system controller 27 is read out from the optical disc 2 and loaded in the memory before the application program controls the operation of the USB device (externally connected device) 13. The system controller 27 executes the instructions described in the class driver that is loaded in the memory and performs control operations as the driver of the USB interface.

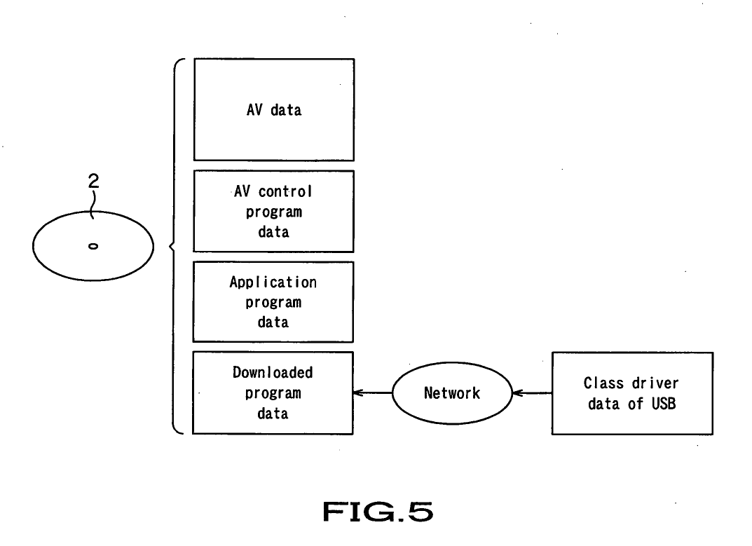

Alternatively, it may be so arranged that a downloaded program is stored in the optical disc 2 and the class driver data of USB is loaded in the system controller 27 by way of the network as the downloaded program is executed as shown in FIG. 5.

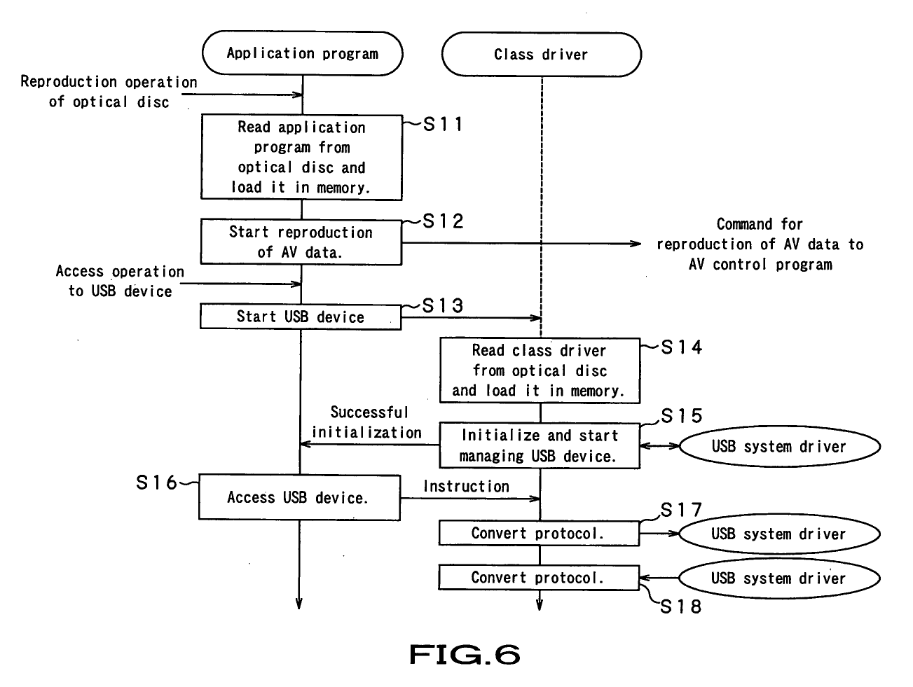

Now, the operation of the system controller 27 will be specifically described by referring to the flowchart of FIG. 6. In the flowchart of FIG. 6, the left side shows the temporal operation sequence to be followed by the system controller 27 according to the description of the application program whereas the right side shows the temporal operation sequence to be followed by the system controller 27 according to the description of the class driver.

As the user operates the optical disc replaying reproduction apparatus 10 to start operating the optical disc 2, firstly in Step S11, the system controller 27 reads out the application program stored in the optical disc 2 and loads it in the memory.

Subsequently, in Step S12, the system controller 27 starts operating according to the application program loaded in the memory and, as it starts operating, it issues a command for starting reproduction of AV data to the AV control program. As a result, it is started to reproduce AV data.

Thereafter, as a user or the like operates the apparatus 10 and issues an instruction for accessing the USB device (externally connected device) 13, the system controller 27 starts operating the USB device according to the instruction of the application program in Step S13.

As the USB device starts operating, the system controller 27 reads out the class driver from the optical disc 2 and loads it in the memory in Step S14.

Subsequently, the system controller 27 initializes the USB interface in Step S15 and, as it initializes the USB interface successfully, it manages the USB device (externally connected device) 13.

As the system controller 27 starts managing the USB device (externally connected device) 13 as described above and when the apparatus 10 starts accessing the USB device according to the application program (Step S16), the class driver operates for protocol conversion of the instruction in response to the access and transfers the instruction to the USB system driver (Step S17). If there is a response of the USB device to the access, the class driver operates for protocol conversion of the response and transfers the response to the application program (Step S18).

In this way, the optical disc 2 stores the driver program that is required to control the operation of the externally connected device 13 along with the application program for controlling the externally connected device 13 and provides them to the user.

With this arrangement, it is now possible to have the optical disc replaying reproduction apparatus 10 to reliably control the externally connected device 13 even when the latter is a special device.

When the externally connected device 13 connected to the apparatus 10 is a device that is required to ensure the security of the data to be exchanged (e.g., a card reader or the like), the optical disc 2 also provides driver software for securing the data communication between the optical disc replaying reproduction apparatus 10 and the externally connected device 13.

Now, a modified arrangement where a mediation driver is provided in the USB driver will be described below.

When the optical disc replaying reproduction apparatus 10 is mounted with an interface of USB, there will be a demand as a matter of course that the application programs incorporated in the apparatus 10 at the time of shipment from the manufacturing plant can also utilize the USB. Assume here that there is a demand for a functional feature of taking in images from a digital camera 30 connected to the USB interface and preparing an album of the images to be incorporated as a standard feature of the optical disc replaying reproduction apparatus 10. In such a case, a class driver and an application program to be used for a digital camera 30 are incorporated in the ROM of the optical disc replaying reproduction apparatus 10 in advance.

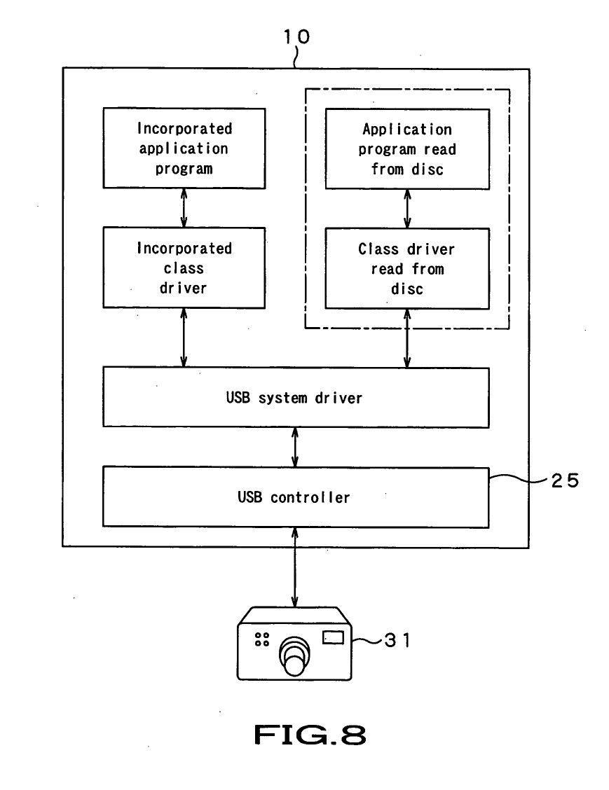

In such a situation, as an optical disc 2 that stores an application program for utilizing an USB device 31 (e.g., an optical disc 2 having a functional feature of taking in a photograph of its own from the digital camera and pasting it to the scenes of a moving picture) is loaded in the optical disc replaying reproduction apparatus 10 and the application program tries to utilize the USB device 31 as shown in FIG. 8, two class drivers are started for a single USB device 31 at the same time.

While such an accident does not occur in an ordinary computer, it arises because two suppliers of class drivers (or secure communication drivers) including the incorporated ROM and the optical disc 2 are involved.

Under the circumstances, a conflict takes place between “the application program incorporated in the ROM” and “the application program read out from the optical disc” as they try to control the same USB device at the same time to give rise to an operation failure of the communication protocol.

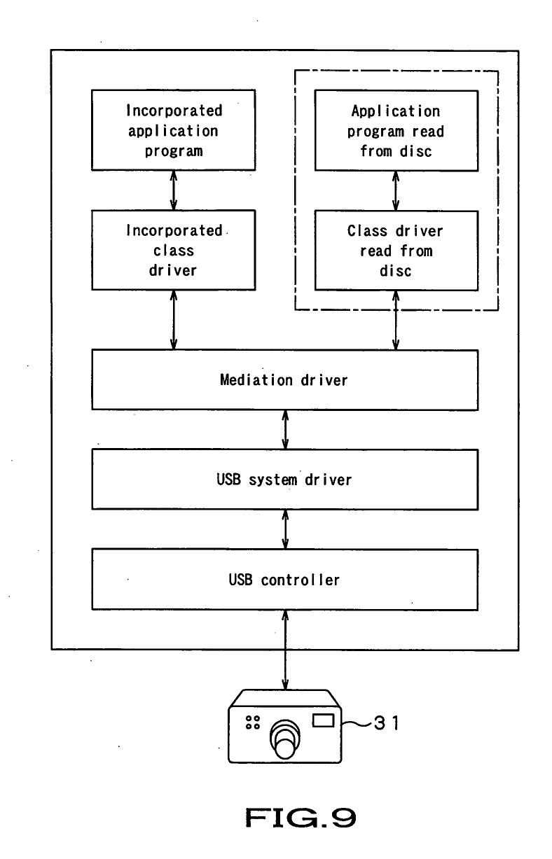

Thus, a mediation driver having a mediation feature for avoiding such a conflict is inserted between the class driver and the USB driver in the optical disc replaying reproduction apparatus 10 as shown in FIG. 9. The mediation driver plays a role of preventing the two drivers from interfering with each other. Various techniques may be conceivable for the mediation and such techniques include one with which the mediation driver give rise to a pseudo-plugged-in (pseudo-connected) state and a pseudo-unplugged (pseudo-disconnected) state.

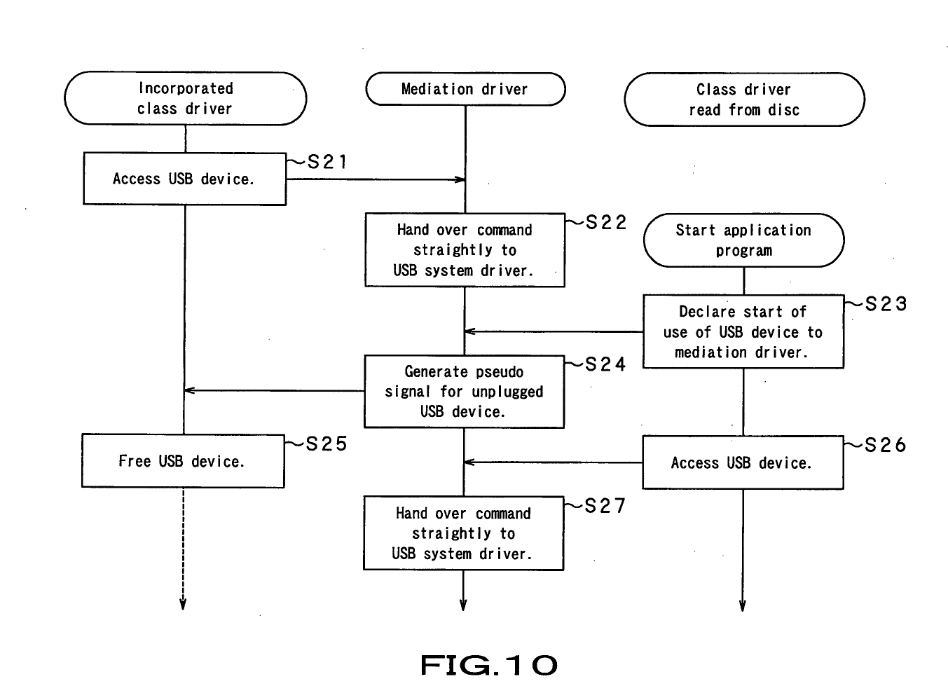

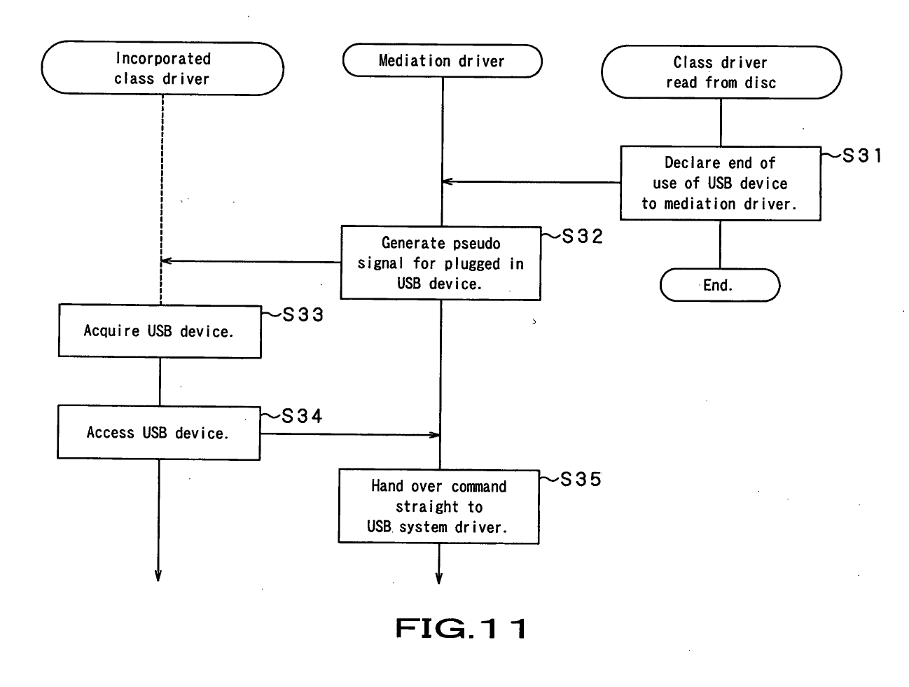

Now, an example of operation of controlling a pseudo-plugged-in (pseudo-connected) state and a pseudo-unplugged (pseudo-disconnected) state will be described below by referring to FIGS. 10 and 11.

FIG. 10 is a flowchart of a process to be executed at the time of pseudo-unplugging and FIG. 11 is a flowchart of a process to be executed at the time of pseudo-plugging-in.

Note that, in the following description, the class driver that is incorporated in advance is referred to as “incorporated class driver” and the application program that is incorporated in advance is referred to as “incorporated application program”. Similarly, the class driver that is read out from the optical disc 2 is referred to as “read out class driver” and the application program that is read out from the optical disc 2 is referred to as “read out application program”.

Now, the flow of operation at the time of pseudo-unplugging will be described by referring to the flowchart of FIG. 10. Note that, in the flow chart of FIG. 10, the left side shows the temporal operation sequence to be followed by the system controller 27 according to the description of the incorporated class driver whereas the right side shows the temporal operation sequence to be followed by the system controller 27 according to the description of the read out class driver. The middle part of FIG. 10 shows the temporal operation sequence to be followed by the system controller 27 according to the description of the mediation driver.

Firstly, in Step S21, the incorporated class driver accesses the USB device. As the incorporated class driver accesses the USB device, the mediation driver straightly hands over the access to the USB system driver in Step S22.

As the application program that is read out from the optical disc starts, the read out class driver declares the start of use of the USB device to the mediation driver in Step S23.

Subsequently, in Step S24, the mediation driver generates a pseudo signal indicating that the USB device is taken away (unplugged) to the incorporated class driver.

As the pseudo signal indicating that the USB device is unplugged is generated, the incorporated class driver frees the USB driver in Step S25. In this way, the mediation driver prevents the two class drivers from interfering with each other.

As the incorporated class driver frees the USB device, the read out class driver accesses the USB device in Step S26. As the read out class driver accesses the USB device, the mediation driver straightly hands over the access to the USB system driver in Step S27.

Now, the flow of operation at the time of pseudo-plugging-in will be described by referring to the flowchart of FIG. 11. Note that, in the flowchart of FIG. 11, the left side shows the temporal operation sequence to be followed by the system controller 27 according to the description of the incorporated class driver whereas the right side shows the temporal operation sequence to be followed by the system controller 27 according to the description of the read out class driver. The middle part of FIG. 11 shows the temporal operation sequence to be followed by the system controller 27 according to the description of the mediation driver.

Firstly, in Step S31, the read out class driver declares the end of use of the USB device to the mediation driver in Step S31.

As the read out class driver declares the end of use of the USB device, the mediation driver generates a pseudo signal indicating that the USB device is connected (plugged in) to the incorporated class driver in Step S32.

Subsequently, in Step S33, the incorporated class driver acquires the USB device. As the incorporated class driver acquires the USB device, it accesses the USB device in Step S34. As the incorporated class driver accesses the USB device, the mediation driver straightly hands over the access to the USB system driver in Step S35.

Thus, as the mediation driver produces a pseudo-plugged-in state and a pseudo-unplugged state, it is possible to prevent a conflict from taking place between the application program incorporated in the ROM and the application program read out from the optical disc.

It should be understood by those skilled in the art that various modifications, combinations, sub-combinations and alterations may occur depending on design requirements and other factors insofar as they are within the scope of the appended claims or the equivalents thereof.

What is claimed is:

1. A recording medium to be removably loaded in and used by a reproduction apparatus for reproducing audiovisual data including those of sounds and/or images, the recording medium storing:
audiovisual data to be reproduced by the reproduction apparatus;
an application program to be executed by a control section of the reproduction apparatus to control reproduction of the audiovisual data and also a predetermined external device connected to the reproduction apparatus by way of a predetermined interface; and
a driver program to be executed by the control section of the reproduction apparatus to communicate with the external device by way of the predetermined interface or a downloading program for downloading the driver program from a network;
the application program describing an instruction for causing the control section to read out the driver program or download it from the network and execute it before operating the external device.

2. The recording medium according to claim 1, wherein the driver program includes a program to be used for secure communications between the control section and the predetermined external device by way of the predetermined interface.

3. An audiovisual data reproduction method of reproducing audiovisual data including those of sounds and/or images stored in a recording medium by means of a reproduction apparatus, the method comprising the steps of:
storing audiovisual data to be reproduced by a reproduction apparatus, an application program to be executed by the control section of the reproduction apparatus to control reproduction of the audiovisual data and also a predetermined external device connected to the reproduction apparatus by way of a predetermined interface and a driver program to be executed by the control section of the reproduction apparatus to communicate with the external device by way of the predetermined interface or a downloading program for downloading the driver program from a network;
causing the control section to read out audiovisual data and the application program from the recording medium and reproduce and execute the application program; and
causing sad control section to read out the driver program or download it from the network and execute it before operating the external device according to a corresponding instruction of the application program.

4. The method according to claim 3, wherein
the control section is adapted to execute a mediation program and,
when the driver program for communication with the predetermined external device by way of the predetermined interface and some other driver program for communication with some other external device by way of the predetermined interface are being executed concurrently by the control section, the mediation program stops the execution of the driver program for communication with the some other external device if the driver program for communication with the predetermined external device is being executed by the application program.
